(19) United States
(12) Patent Application Publication
(10) Pub. No.: US 2015/0311568 A1
(43) Pub. Date: Oct. 29, 2015

(54) BATTERY PACK

(71) Applicant: Samsung SDI Co., Ltd., Yongin-si (KR)

(72) Inventors: Bo-Hyun Byun, Yongin-si (KR); Sung-Pyo Hong, Yongin-si (KR)

(21) Appl. No.: 14/581,695

(22) Filed: Dec. 23, 2014

(30) Foreign Application Priority Data
Apr. 23, 2014 (KR) 10-2014-0048878

(51) Int. Cl. H01M 10/42; H01M 2/10

(52) U.S. Cl. CPC H01M 10/4257; H01M 2/1061; H01M 2220/30

(57) ABSTRACT

A battery pack includes a battery cell unit including a plurality of terminals for transmitting signals and current; an outer cover covering an upper portion of the battery cell unit to shield the terminals from surrounding factors; a flexible circuit board unit between the outer cover and the battery cell unit and contacting the terminals, the flexible circuit board unit including a first portion extending outward through a side of the outer cover in the first direction, a second portion bent from the first portion and around the edge of the outer cover, and a third portion bent from the second portion in a second direction, the third portion forming an angle with the upper surface of the outer cover; and a fixing part on the outer cover and accommodating the third portion of the flexible circuit board unit.

### CROSS-REFERENCE TO RELATED APPLICATION

This application claims priority to and the benefit of Korean Patent Application No. 10-2014-0048878, filed on Apr. 23, 2014, in the Korean Intellectual Property Office, the entire content of which is incorporated herein by reference.

### BACKGROUND

1. Field

One or more embodiments of the present invention are directed to a battery pack.

2. Description of the Related Art

The development of wireless communications increased the demand for small and portable electronic devices that are equipped with batteries and can be used when a power outlet is not available A battery pack may be made up of rechargeable unit cells in order to deliver sufficient output power.

### SUMMARY

One or more embodiments of the present invention are directed to a battery pack.

Additional aspects will be set forth in part in the description which follows and, in part, will be apparent from the description, or may be learned by practice of the presented embodiments.

According to one or more embodiments of the present invention, a battery pack includes a battery cell unit including a plurality of terminals; an outer cover covering an upper portion of the battery cell unit; a flexible circuit board unit between the outer cover and the battery cell unit and contacting the terminals, the flexible circuit board unit including a first portion extending outward through a side of the outer cover in the first direction, a second portion bent from the first portion and around an edge of the outer cover, and a third portion bent from the second portion in a second direction, the third portion forming an angle with the upper surface of the outer cover, and a fixing part on the outer cover and accommodating the third portion of the flexible circuit board unit.

The outer cover may include a pullout slot through which the flexible circuit board unit may extend outward.

The fixing part may form a right angle with the upper surface of the outer cover.

The fixing part may include: a guide portion protruding from the upper surface of the outer cover in the second direction; a lateral portion bent from the guide portion; and a support portion bent from the lateral portion.

The guide portion may be spaced from and may face the support portion.

A distance between the guide portion and the support portion may be different from a thickness of a part of the third portion of the flexible circuit board unit.

The distance between the guide portion and the support portion may be greater than the thickness of the part of the third portion of the flexible circuit board unit.

The support portion may include: a first support portion; and a second support portion facing the first support portion.

A shortest distance between the first and second support portions may be smaller than a width of the part of the third portion of the flexible circuit board unit.

The support portion may be spaced from the upper surface of the outer cover.

The distance between the upper surface of the outer cover and the support portion may be different from a thickness of the second portion of the flexible circuit board unit.

The distance between the upper surface of the outer cover and the support portion may be greater than the thickness of the second portion of the flexible circuit board unit.

The battery pack may further include a label surrounding the battery cell unit.

A portion of the label may extend toward the upper surface of the outer cover so as to shield the side of the outer cover through which the flexible circuit board unit extends outward.

The flexible circuit board unit may include: a contact part contacting the terminals; a cable part coupled to the contact part; and a connector part coupled to an end of the cable part and configured to be connected to an external device.

According to one or more embodiments of the present invention, a battery pack includes: a unit cell; a protective circuit module electrically connected to the unit cell and including a plurality of terminals; an outer cover on the protective circuit module; a flexible circuit board unit between the outer cover and the protective circuit module and contacting the terminals, the flexible circuit board unit including a first portion extending outward through a side of the outer cover in the first direction, a second portion bent from the first portion and around an edge of the outer cover, and a third portion bent from the second portion in a second direction, the third portion forming an angle with the upper surface of the outer cover; and a fixing part formed on the outer cover and forming an angle with the upper surface of the outer cover, the fixing part securing a portion of the flexible circuit board unit while allowing for the movement of the portion of the flexible circuit board unit.

The fixing part may include: a guide portion protruding from the upper surface of the outer cover in the second direction; a lateral portion bent from the guide portion; and a support portion bent from the lateral portion.

The guide portion may be spaced from and may face the support portion.

A distance between the guide portion and the support portion may be greater than a thickness of a part of the third portion of the flexible circuit board unit.

The support portion may be spaced from the upper surface of the outer cover, and the distance between the support portion and the upper surface of the outer cover may be greater than the thickness of the second portion of the flexible circuit board unit.

### BRIEF DESCRIPTION OF THE DRAWINGS

These and/or other aspects will become apparent from the following description of embodiments, taken in conjunction with the accompanying drawings in which:

FIG. 1 is a perspective view illustrating a battery pack according to an embodiment of the present invention;

FIG. 2 is a partially exploded perspective view illustrating the battery pack of FIG. 1;

FIG. 3 is a perspective view illustrating an outer cover of FIG. 2;

FIG. 4 is an enlarged perspective view illustrating a fixing part of FIG. 3;

FIG. 5 is a perspective view illustrating a protective circuit module and a flexible circuit board unit of FIG. 2;

FIG. 6 is a perspective view illustrating one step of positioning the flexible circuit board unit on the fixing part of FIG. 3; and

FIG. 7 is a perspective view illustrating another step of positioning the flexible circuit board unit on the fixing part of FIG. 3.

### DETAILED DESCRIPTION

Reference will now be made to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” In the following description, technical terms are used only for explaining exemplary embodiments, and not for purposes of limitation. Terms in the singular form may include the plural form unless specifically mentioned. The meaning of “comprises” and/or “comprising” specifies an element, a step, a process, an operation, and/or a device but does not exclude other elements, steps, processes, operations, and/or devices. It will be understood that although the terms such as “first” and “second” are used herein to describe various elements, these elements should not be limited by these terms. Terms are only used to distinguish one element from other elements.

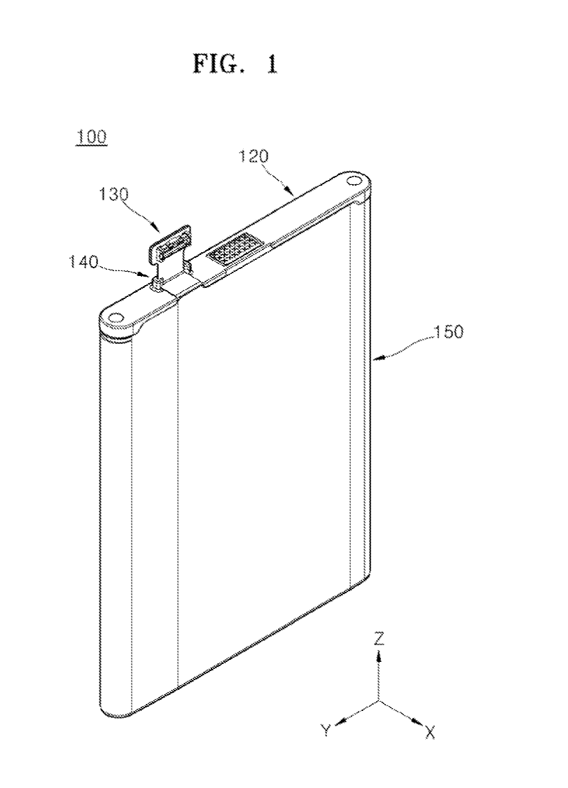

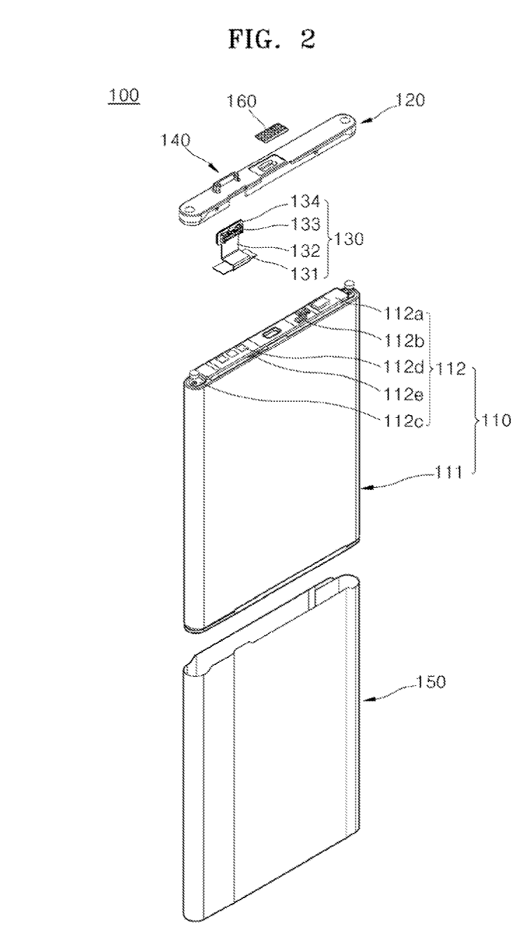

FIG. 1 is a perspective view illustrating a battery pack 100 according to an embodiment of the present invention. FIG. 2 is an exploded perspective view illustrating the battery pack 100 illustrated in FIG. 1.

Referring to FIGS. 1 and 2, the battery pack 100 may include a battery cell unit 110, an outer cover 120, a flexible circuit board unit 130, a fixing part 140, and a label 150.

The battery cell unit 110 may include a unit cell 111 and a protective circuit module 112. The unit cell 111 may include a can having an accommodation space, an electrode assembly inserted into the accommodation space of the can, and a cap plate positioned on an upper side of the can. The electrode assembly may be a jelly-roll secondary battery electrode assembly. The can, the electrode assembly, and the cap plate may be identical or similar to those of conventional secondary batteries and should be apparent to those of ordinary skill in the art, and thus, detailed descriptions thereof will not be provided.

In one embodiment, the protective circuit module 112 may be positioned on an upper surface of the unit cell 111 and may be electrically connected to the unit cell 111 so as to control the charging and discharging operations of the unit cell 111 and prevent (or reduce) overheating and explosion of the unit cell 111 that may be caused by overcharging, overdischarging, or an overcurrent.

The protective circuit module 112 may include a circuit board 112a, protection devices 112b on the circuit board 112a, connection members 112c, and external terminals 112d. The external terminals 112d may be connected to an external device to either supply electricity from the unit cell 111 to the external device or to receive electricity from the external device, and to transmit or receive signals for controlling the charging and/or discharging of the unit cell 111. The protection devices 112b may be positioned between the unit cell 111 and the circuit board 112a and may form a circuit for controlling the charging and discharging of the unit cell 111.

The connection members 112c may be placed on both ends of the circuit board 112a to electrically connect the circuit board 112a and the cap plate. In one embodiment, the connection members 112c are arranged such that the circuit board 112a is spaced from the cap plate.

In addition to the above-described elements, the protective circuit module 112 may further include a temperature device 112e that electrically connects the unit cell 111 and the circuit board 112a. In one embodiment, if the temperature of the unit cell 111 increases, the temperature device 112e may sever the connection between the unit cell 111 and the circuit board 112a. The temperature device 112e may be identical or similar to those used in conventional secondary batteries and should be apparent to those of ordinary skill in the art, and thus, a detailed description thereof will not be provided.

The outer cover 120 may be positioned on top of the protective circuit module 112. In one embodiment, the outer cover 120 may entirely cover the protective circuit module 112 to shield the protective circuit module 112 from the surrounding environment.

The flexible circuit board unit 130 may connect the external terminals 112d of the protective circuit module 112 to an external device. In one embodiment, the flexible circuit board unit 130 may be partially bent and may extend outward from the side of the outer cover 120 so as to be bent around the edges of the outer cover 120 and laid across an upper surface of the outer cover 120.

The flexible circuit board unit 130 may include a contact part 131, and the contact part 131 may be in contact with the external terminals 112d and may be fixed to the external terminals 112d. In one embodiment, the contact part 131 and the external terminals 112d may be soldered together or fixed together using a resin. In one embodiment, in order to facilitate the connection of the contact party 131 with the external terminals 112d, the contact part 131 may have a plate shape and may include separate terminals respectively corresponding to the external terminals 112d.

The flexible circuit board unit 130 may include a cable part 132 connected to the contact part 131. The cable part 132 may include a plurality of flexible cables that allow a flow of current and signals therethrough.

The flexible circuit board unit 130 may further include a connector part 133 connected to the end of the cable part 132. The connector part 133 may correspond to a connection unit of the external device. Specifically, the connector part 133 may have a protruded or grooved shape corresponding to the shape of the connection unit of the external device, so as to be connected and fixed to the connection unit.

The flexible circuit board unit 130 may include a reinforcement part 134 positioned on a rear side of the connector part 133. The reinforcement part 134 may have a plate shape and may be attached to the portion of the connector part 133 that is connected to the cable part 132.

The fixing part 140 may be formed on the upper surface of the outer cover 120 and may form an angle with the upper surface of the outer cover 120. In one embodiment, the fixing part 140 may protrude upward from the upper surface of the outer cover 120. The fixing part 140 may be coupled to and may hold in place the flexible circuit board unit 130, while at the same time allowing for the movement of the flexible circuit board unit 130.

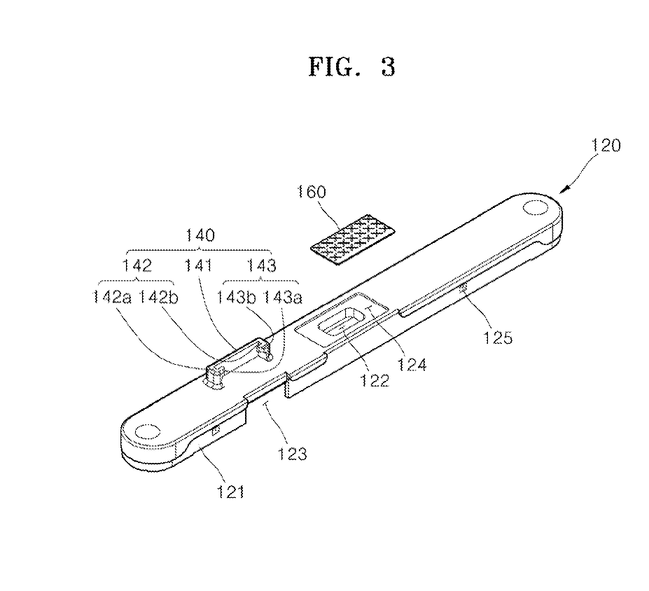

The label 150 may be wrapped around the unit cell 111. The label 150 may be formed of an insulation material, and a portion of the label 150 may extend to cover the edges of the protective circuit module 112. Referring to FIG. 3, the outer cover 120 may include a recess 121 formed around an outer edge of the outer cover 120, and a portion of the label 150 may be placed inside the recess 121. Accordingly, the outer cover 120 and the label 150 may shield the battery cell unit 110 and the protective circuit module 112 from the surrounding environment.

Hereinafter, the outer cover 120 and the fixing part 140 will be described with reference to the figures.

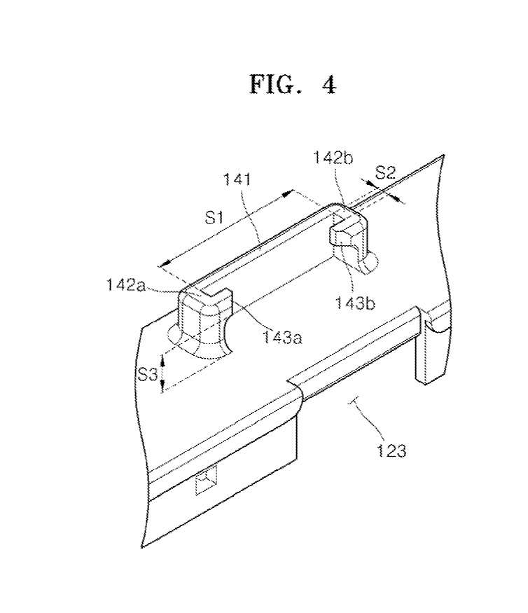

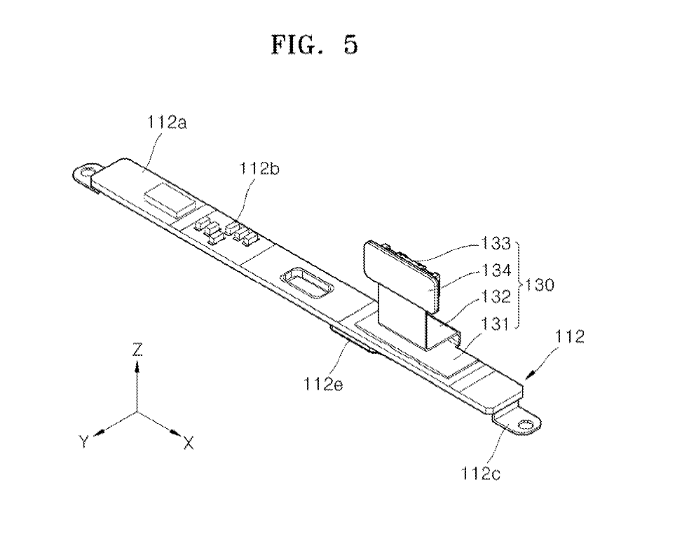

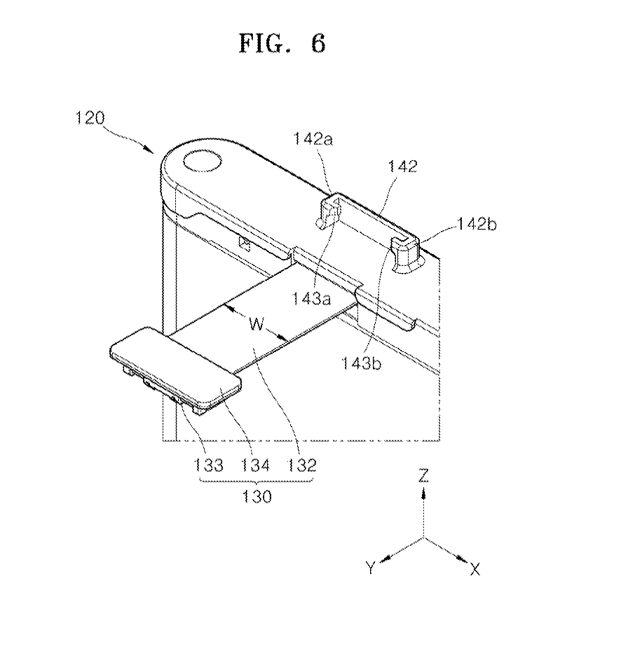

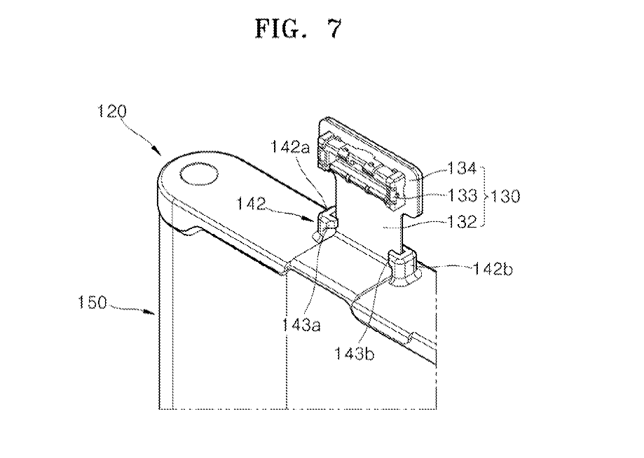

FIG. 3 is a perspective view illustrating the outer cover 120 illustrated in FIG. 2. FIG. 4 is an enlarged perspective view illustrating the fixing part 140 illustrated in FIG. 3. FIG. 5 is a perspective view illustrating the protective circuit module 112 and the flexible circuit board unit 130 illustrated in FIG. 2. FIG. 6 is a perspective view illustrating a step in positioning the flexible circuit board unit 130 on the fixing part 140 illustrated in FIG. 3. FIG. 7 is a perspective view illustrating another step in positioning the flexible circuit board unit 130 on the fixing part 140 illustrated in FIG. 3.

Referring to FIGS. 3 to 7, the outer cover 120 may have an accommodation space therein, and the protective circuit module 112 may be placed in the accommodation space of the outer cover 120. The outer cover 120 may include a first welding hole 122 for welding a terminal of the protective circuit module 112 and a portion of the temperature device 112e. Furthermore, coupling protrusions may be formed on a rear (bottom) surface of the outer cover 120 around the welding hole 122 for coupling with second welding holes of the circuit board 112a. The coupling protrusions may protrude from the rear (bottom) surface of the outer cover 120 toward the circuit board 112a.

The outer cover 120 may include a pullout slot 123, and a portion of the flexible circuit board unit 130 may extend outward from the outer cover 120 through the pullout slot 123. In one embodiment, the pullout slot 123 may be formed in a lateral (longer) side of the outer cover 120. The width of the pullout slot 123 may be equal or approximately equal to the width W of the cable part 132, as illustrated in FIG. 6.

A shield plate 160 may be positioned on the first welding hole 122 of the outer cover 120. To accommodate the shield plate 160, the outer cover 120 may include a shield plate recess 124, and the shield plate 160 may be positioned in the shield plate recess 124. The shield plate 160 may be formed of a material identical or similar to a material used to form the outer cover 120, or a material different from the one used to form the outer cover 120. In one embodiment, the shield plate 160 and the outer cover 120 may be coupled to each other by any suitable welding or bonding method.

The outer cover 120 may include stopper protrusions 125 protruding inward toward the middle of the outer cover 120. The stopper protrusions 125 of the outer cover 120 may be brought into contact with or hooked on the protective circuit module 112 and/or the battery cell unit 110, thus fixing the outer cover 120 to the protective circuit module 112 and/or the battery cell unit 110.

The fixing part 140 may be formed on the upper surface of the outer cover 120 and may form an angle with the upper surface of the outer cover 120. In one embodiment, the fixing part 140 may protrude outward from the upper surface of the outer cover 120 and may form a right angle with the upper surface of the outer cover 120. However the angle between the fixing part 140 and the upper surface of the outer cover 120 is not limited to a right angle. Hereinafter, solely for convenience of description, it will be assumed that the angle between the fixing part 140 and the upper surface of the outer cover 120 is a right angle.

Referring to FIGS. 3 and 4, the fixing part 140 may include a guide portion 141 connected to the upper surface of the outer cover 120. In one embodiment, the guide portion 141 may guide the flexible circuit board unit 130 to be positioned upright relative to the upper surface of the outer cover 120. The fixing part 140 may further include a lateral portion 142 bent from the guide portion 141 to cover (surround) the side edges of the flexible circuit board unit 130.

The fixing part 140 may also include a support portion 143 bent from the lateral portion 142. The support portion 143 may be spaced from the guide portion 141.

The lateral portion 142 may include a first lateral portion 142a bent from one side of the guide portion 141, and a second lateral portion 142b bent from the other side of the guide portion 141 and facing the first lateral portion 142a.

A distance S1 between the first and second lateral portions 142a and 142b may be equal or approximately equal to the width of the flexible circuit board unit 130. Specifically, the distance S1 between the first and second lateral portions 142a and 142b may be equal or approximately equal to the width W of the cable part 132.

As described above, the support portion 143 formed on the lateral portion 142 may face the guide portion 141, and a space may be formed between the support portion 143 and the guide portion 141. In one embodiment, a distance S2 between the support portion 143 and the guide portion 141 may be different from the thickness of a portion of the flexible circuit board unit 130 inserted between the guide portion 141 and the support portion 143. For example, the distance S2 between the support portion 143 and the guide portion 141 may be greater than the thickness of the cable part 132 of the flexible circuit board unit 130.

In one embodiment, the fixing part 140 may include a plurality of support portions 143. In one embodiment, the plurality of support portions 143 may include a first support portion 143a and a second support portion 143b facing the first support portion 143a. The first support portion 143a may be bent from the first lateral portion 142a and may protrude inward toward the middle of the guide portion 141, and the second support portion 143b may be bent from the second lateral portion 142b and may protrude inward toward the middle of the guide portion 141.

A distance between the first and second support portions 143a and 143b may be smaller than the width of the flexible circuit board unit 130. For example, the shortest distance between the first and second support portions 143a and 143b may be smaller than the width W of the cable part 132 of the flexible circuit board unit 130.

At least one of the first and second support portions 143a and 143b may be spaced by a distance S3 from the upper surface of the outer cover 120. The distance S3 from the upper surface of the outer cover 120 to the at least one of the first and second support portions 143a and 143b may be different from the thickness of the flexible circuit board unit 130. For example, the distance S3 from the upper surface of the outer cover 120 to the at least one of the first and second support portions 143a and 143b may be greater than the thickness of the cable part 132 of the flexible circuit board unit 130.

The battery pack 100 may be manufactured as follows. First, the unit cell 111 and the protective circuit module 112 may be manufactured and coupled to each other. At this time, the contact part 131 of the flexible circuit board unit 130 may be positioned on the external terminals 112d of the protective circuit module 112.

Then, the unit cell 111 may be covered with the label 150, and the outer cover 120 may be attached to the unit cell 111. At this time, the stopper protrusions 125 of the outer cover 120 may be brought into contact with or hooked on the circuit board 112a, thus fixing the outer cover 120 to the circuit module 112 and the unit cell 111. Part of the label 150 may be placed in the recess 121 formed on the outer edges of the outer cover 120. Accordingly, the label 150 may shield the unit cell 111 and the protective circuit module 112 from the surrounding environment.

The cable part 132 may be pulled out from inside the outer cover 120 through the pullout slot 123. In order to shield the inside of the outer cover 120 exposed after the cable part 132 is pulled out, part of the label 150 may extend toward the outer cover 120 and may be spaced from a portion of the outer cover 120 in which the pullout slot 123 is formed.

Thereafter, the cable part 132 may be bent around the edge of the outer cover 120 where the pullout slot 123 is formed and may be laid across the upper surface of the outer cover 120.

Thereafter, the cable part 132 may be inserted between the first and second lateral portions 142a and 142b. Since the distance S1 between the first and second lateral portions 142a and 142b is equal or approximately equal to the width W of the cable part 132, the cable part 132 may be easily inserted between the first and second lateral portions 142a and 142b.

Herein, the cable part 132 may be bent again, along the side of the guide portion 141, so as to form a right angle with the upper surface of the outer cover 120.

The bent cable part 132 may be positioned between the guide portion 141 and the first and second support portions 143a and 143b. The distance S2 from the guide portion 141 to the first and second support portions 143a and 143b may be greater than the thickness of the cable part 132. Accordingly, the cable part 132 may move between the guide portion 141 and the first and second support portions 143a and 143b.

After the flexible circuit board unit 130 is positioned as described above, the connector part 133 may be positioned away from the upper surface of the outer cover 120.

Then, the battery pack 100 may be attached to an external device such as a cellular phone or a laptop computer. In this case, the connector part 133 may be connected to a connection unit of the external device to supply power to the external device.

When the battery pack 100 is connected to an external device as described above, an impact on the external device or movement of the battery pack 100 may cause the cable part 132 to be bent or moved. However, since the fixing part 140 holds the cable part 132 in place, the fixing part 140 may prevent (or reduce) bending or movement of the cable part 132, thus preventing (or reducing) damage to the cable part 132 or the possibility of the cable part 132 being disconnected from the external device.

Furthermore, the fixing part 140 allows for movement of the cable part 132. Accordingly, when the battery pack 100 is moved or the external device is hit (or otherwise impacted), the damage to the cable part 132 from the fixing part 140 itself may be prevented (or reduced).

In other words, the flexible circuit board unit 130 may be securely fixed, and the separation of the flexible circuit board unit 130 may be prevented (or reduced), while still allowing movement of the flexible circuit board unit 130 within a predetermined range inside the fixing part 140.

Accordingly, the damage to the flexible circuit board unit 130 of the battery pack 100 can be prevented (or reduced), and a stable connection between the unit cell 111 and the external device may be established.

In one embodiment, the structure of the fixing part 140 holding the flexible circuit board unit 130 may allow for the flexible circuit board unit 130 of the battery pack 100 to be easily assembled.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims and equivalents thereof.

What is claimed is:

1. A battery pack comprising:
a battery cell unit comprising a plurality of terminals;
an outer cover covering an upper portion of the battery cell unit;
a flexible circuit board unit between the outer cover and the battery cell unit and contacting the terminals, the flexible circuit board unit comprising a first portion extending outward through a side of the outer cover in the first direction, a second portion bent from the first portion and around an edge of the outer cover, and a third portion bent from the second portion in a second direction, the third portion forming an angle with the upper surface of the outer cover; and
a fixing part on the outer cover and accommodating the third portion of the flexible circuit board unit.

2. The battery pack of claim 1, wherein the outer cover comprises a pullout slot through which the flexible circuit board unit extends outward.

3. The battery pack of claim 1, wherein the fixing part forms a right angle with the upper surface of the outer cover.

4. The battery pack of claim 1, wherein the fixing part comprises:
a guide portion protruding from the upper surface of the outer cover in the second direction;
a lateral portion bent from the guide portion; and
a support portion bent from the lateral portion.

5. The battery pack of claim 4, wherein the guide portion is spaced from and faces the support portion.

6. The battery pack of claim 4, wherein a distance between the guide portion and the support portion is different from a thickness of a part of the third portion of the flexible circuit board unit.

7. The battery pack of claim 6, wherein the distance between the guide portion and the support portion is greater than the thickness of the part of the third portion of the flexible circuit board unit.

8. The battery pack of claim 4, wherein the support portion comprises:
a first support portion; and
a second support portion facing the first support portion.

9. The battery pack of claim 8, wherein a shortest distance between the first and second support portions is smaller than a width of the part of the third portion of the flexible circuit board unit.

10. The battery pack of claim 4, wherein the support portion is spaced from the upper surface of the outer cover.

11. The battery pack of claim 10, wherein the distance between the upper surface of the outer cover and the support portion is different from a thickness of the second portion of the flexible circuit board unit.

12. The battery pack of claim 11, wherein the distance between the upper surface of the outer cover and the support portion is greater than the thickness of second portion of the flexible circuit board unit.

13. The battery pack of claim 1, further comprising a label surrounding the battery cell unit.

14. The battery pack of claim 13, wherein a portion of the label extends toward the upper surface of the outer cover and shields the side of the outer cover through which the flexible circuit board unit extends outward.

15. The battery pack of claim 1, wherein the flexible circuit board unit comprises:
a contact part contacting the terminals;
a cable part coupled to the contact part; and
a connector part coupled to an end of the cable part and configured to be connected to an external device.

16. A battery pack comprising:
a unit cell;
a protective circuit module electrically connected to the unit cell and comprising a plurality of terminals;
an outer cover on the protective circuit module;
a flexible circuit board unit between the outer cover and the protective circuit module and contacting the terminals, the flexible circuit board unit comprising a first portion extending outward through a side of the outer cover in the first direction, a second portion bent from the first portion and around the edge of the outer cover, and a third portion bent from the second portion in a second direction, the third portion forming an angle with the upper surface of the outer cover; and
a fixing part on the outer cover and forming an angle with the upper surface of the outer cover, the fixing part securing a portion of the flexible circuit board unit while allowing for the movement of the portion of the flexible circuit board unit.

17. The battery pack of claim 16, wherein the fixing part comprises:
a guide portion protruding from the upper surface of the outer cover in the second direction;
a lateral portion bent from the guide portion; and
a support portion bent from the lateral portion.

18. The battery pack of claim 17, wherein the guide portion is spaced from and faces the support portion.

19. The battery pack of claim 18, wherein a distance between the guide portion and the support portion is greater than a thickness of a part of the third portion of the flexible circuit board unit.

20. The battery pack of claim 17, wherein the support portion is spaced from the upper surface of the outer cover, and the distance between the support portion and the upper surface of the outer cover is greater than the thickness of the second portion of the flexible circuit board unit.
